(19) United States
(12) Patent Application Publication
(10) Pub. No.: US 2009/0308138 A1
(43) Pub. Date: Dec. 17, 2009

(54) PROCESS FOR MEASURING THE UNIFORM FILLING OF REACTORS WITH SOLID BODIES

(75) Inventors: Achim Fischer, Aschaffenburg (DE); Werner Burkhardt, Brachttal (DE); Jan-Olaf Barth, Frankfurt (DE); Christoph Weckbecker, Grundau-Liebios (DE)

Correspondence Address: PILLSBURY WINTHROP SHAW PITTMAN, LLP, P.O. BOX 10500, MCLEAN, VA, 22102, US

(73) Assignee: Evonik Degussa GmbH, Essen (DE)

(21) Appl. No.: 12/278,927

(22) PCT Filed: Jan. 11, 2007
(86) PCT No.: PCT/EP07/50243

§ 371 Date: May 26, 2009

(30) Foreign Application Priority Data
Feb. 8, 2006 (DE) 10 2006 006 009.1

(51) Int. Cl. G01L 11/00; G01N 7/00

(52) U.S. Cl. 73/37

(57) ABSTRACT

The invention relates to a process for measuring the uniform filling of reactors or columns with solid bodies and to an apparatus for performing the process.

The invention relates to a method for measurement of the even filling with solid bodies of reactors or columns and an apparatus for carrying out the method.

In chemical reaction technology, the even filling of reactors with solid bodies is of critical importance for the efficiency of the apparatus. For example, the solid bodies are random packings or catalysts.

These solid bodies can have different compositions and geometries. They can be spheres, solid or hollow cylinders, or rings, but other geometries are likewise possible.

If the solid bodies are used, for example, in tube-bundle reactors or plate reactors for catalytic reactions, the object is to ensure even filling of these reactors.

EP-A-873 783 discloses a device and a method for temperature measurement in tube reactors. In a tube reactor having a temperature measuring device there is the problem that this device, for example a thermocouple or a resistance thermometer, alters the flow profile and thus the pressure drop behaviour in the tube reactor compared with tube reactors without the temperature measuring device.

This technical problem is solved by the features by which a) the ratio of the mass of the solid particles to the open cross sectional area of the respective tube reactor and b) the pressure drop over the respective tube reactor cross section are equal. It follows therefrom that in tubes having a larger cross section, significantly higher amounts of catalyst need to be charged in order to achieve, at the same filling height, a comparable pressure drop.

EP-A-1 270 065 relates to the inline measurement of the pressure in the reactor space by passing a lance having a pressure sensor through the reactor lid into the solid body bed. This is the customary method for measuring a pressure in an apparatus. If it is desired to determine the backpressure distribution of all tubes, generally several thousand tubes, falsified results would be obtained using this method, since the lance affects the flow of the gas. Pressure measurement in the several thousand tubes would, moreover, only be possible by high expenditure on construction. Thus several thousand measurement lances would have to be led off into the reactor.

WO 02/074428 describes a device and a method for measuring the back pressure of chemical reactor tubes filled with catalysts.

The device consists of a bundle of measurement tubes fixed to one another, the spacing to one another of which must be matched to the spacings of the reaction tubes in the tube-bundle reactor.

Sealing is performed by means of inflatable seals. Dust extraction is not provided.

The object of the invention is to provide a flexible method for measurement of the even filling of reactors with solid bodies, and a device suitable therefor.

The invention relates to a method for measurement of the even filling with solid bodies of reactors or columns which have at least two reaction chambers which are separate from one another and are filled with solid bodies, in particular reaction tubes, by
a) simultaneously passing through at least two of these reaction chambers (reaction tubes) gas or liquid streams of the same composition and amount via the corresponding number of separately mounted gas or liquid inlets (measurement tubes),
b) measuring the back pressure simultaneously at each of these measuring tubes, and
c) centrally recording the values determined,
   which is characterized in that dust is extracted by suction from the volume above the solid body packing via a ring gap surrounding the lower end of the measuring tube in the longitudinal direction and/or the resultant back pressure is allowed to decay.

For this purpose, the seal of the connection between measuring tube and reaction tube which consists of a flexible solid body is loosened, so that an orifice is formed between the space above the solid body bed and the ring gap.

Via this ring gap, then, for example, extraction via suction is performed, or a pressure expansion is performed.

The encasing tube forming the ring gap also still then encloses the reaction tube or the orifice of the reaction space.

Particularly useful reactors are tube-bundle reactors or reactors having reaction and heat-transport spaces separated from one another by thermal sheets.

The columns are, for example, absorption columns.

As gases, generally use is made of inert gases, air or mixtures thereof.

The solid body bed is a resistance to the gas stream which decreases the flow rate and builds up a back pressure.

It is critical in this case that a constant volumetric flow rate is passed through the solid body bed. The volumetric flow rate of the gas should generally have a flow rate of 250 to 5000 l/h, the inlet pressure of the gas should be in the range from 1 bar g to 50 bar g, in particular from 1 to 10 bar g, the temperature of the gas should generally be in the range from 10 to 50° C. Ideally, suitable gases are inert gases, air or mixtures of these.

For constant metering of the gases, for example use is made of a device having a structure as shown in FIG. 1, in which a is the number of parallel gas lines.

The metering is considered to be constant when the flow rate of the gas varies by less than +/−2.5%, particularly suitable flow rates have a fluctuation of less than or equal to +/−1%.

Advantageously, for example, the back pressure is measured in up to 15 parallel gas lines, in particular up to 10, particularly advantageously up to 5. If different measured values result, the filling with the solid bodies used for example as catalysts is not even and must be improved on.

The measurement which is possible according to the invention of a plurality of gas flows at the same time makes possible a time saving method for examining the filling of reactors.

Even is considered to be a variance of up to ±5%.

The invention likewise relates to an apparatus for measurement of the even filling of reactors which contain at least two reaction chambers or reaction tubes with solid bodies which
a) have at least two devices which are not fastened to one another for constant metering of gas or liquid streams and, in association therewith, have the same respective number of devices having measuring tube for measuring the back pressure and a central data store for recording the measured values,
b) the measuring tube introduced into the reaction chamber or reaction tube, or seated thereon, being encased at the introduction end in the longitudinal direction so that a ring gap forms which has a venting port, and
c) this tube case being longer than the measuring tube, having a larger cross section than the inlet orifice into which the measuring tube is introduced or on which it sits, and
d) enclosing the inlet orifice so tightly that no gas escapes during the measurement operation for the back pressure.

For measurement of the back pressure, the gas stream coming, for example, from the apparatus according to FIG. 1 is passed via an apparatus as shown in FIG. 2 into the tubes filled with solid bodies. The back pressures produced are measured using a commercially conventional pressure sensor, for example from Ashcroft Inc., which ideally is mounted on the gas inlet device as shown in FIG. 2. The pressure range of the sensor must extend from 0 to 2500 mbar g, but in particular from 0 to 1000 mbar g. The pressure data determined are transmitted to an electronic store which can hold up to 60 000 pressure data. This data store should ideally be accommodated together with the pressure sensor in one unit.

The introduced or seated measuring tube is encased so that a ring gap (Pos. 5, FIG. 2) is formed. Via this, dust of the charged material can be extracted by suction, when the tight connection between measuring tube and, for example, the reaction tube, is loosened. Extraction of the dust by suction is very important to meet the safety at work requirements. The charged solid bodies must not contain toxic dusts. Via this ring gap, the overpressure resulting from the back pressure which builds up in the interior of the measuring tube can escape upwards when the instrument is taken off. The extraction by suction via (4) and (5) then likewise ensures that the dusts can be extracted by suction and safely removed.

The outer wall of the jacketed shell is ideally fabricated in such a manner that it can lie over the flexible seal (6) as protection. In this case, it can be a metal cover which expands according to the principle of a spring in the solution direction or may be forced together and lies on the outside of the wall of the reactor tube.

It is in addition possible to combine the expansion of the pressure via this ring gap with shutting off the gas stream (7), so that it is not the gas stream (7) which is extracted by suction, but only the back-flowing gas from the filled tube.

The back flow makes it further possible to loosen the upper solid body bed and thus in a simple manner to lower an excessive back pressure which is caused by fine dust in the topmost bed or excessively tight packing of the random packings.

It is in addition possible according to the invention to measure the back pressure in tubes which contain, for example, a thermocouple, which is led out upwards from the tube. In this case a recess is introduced into the seal (6), which recess can receive the thermocouple in a tightly fitting manner.

It is possible to examine the measured value of back pressure via a metering orifice (8) or to calibrate the instrument using this metering orifice. For this purpose a metering orifice (8) is pushed onto the measuring tube instead of the reactor tube and the back pressure determined. The diameter of the orifice should correspond to the diameter of the reactor tube. The width of the hole of the orifice is selected in such a manner that the back pressure which results because of the metering orifice is in the range of the measured values obtained by measurement with the filled reactor tube.

The method is not restricted to measurement of back pressure as a measurement of flow resistance.

It is likewise possible to take other effects of the filling of reactors on the gas flow as a basis for measurements, such as, for example, the pressure drop in the solid bed or the flow velocity.

The gas flow rate can be measured as a volumetric flow rate or mass flow rate.

### DESCRIPTION OF THE FIGURES

FIG. 1

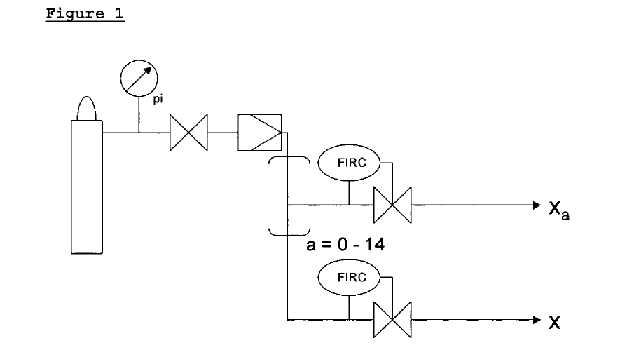

Apparatus for the even metering of the gas flow through a plurality of parallel gas lines.

FIG. 2

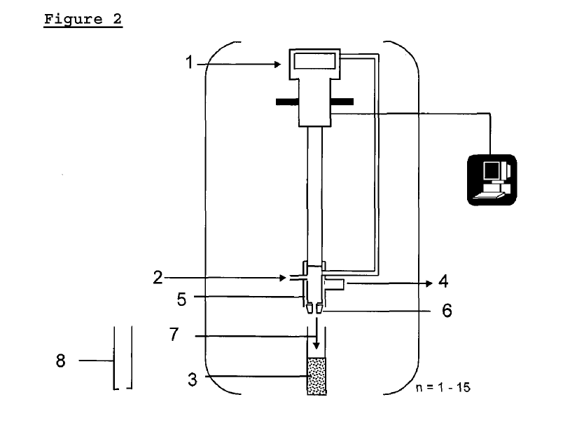

Apparatus for measuring back pressure
1) Pressure meter where appropriate data store
2) Gas inlet from apparatus 1
3) Solid body bed in tube open at both ends
4) Venting port, for example gas and dust extraction by suction
5) Ring gap, outer diameter greater than tube cross section
6) Seal
7) Gas stream introduced for pressure build up
8) Metering orifice for calibration and examination of the measured value

1-4. (canceled)

5. A method for measuring the uniform filling of reactors or columns having at least two reaction chambers separate from one another with solid bodies, the method comprising:
simultaneously passing gas or liquid streams having the same composition and amount through at least two of the reaction chambers via a corresponding number of separately mounted measurement tubes;
simultaneously measuring a back pressure at each of the measuring tubes;
centrally recording the measured back pressure; and
extracting dust by suction from a volume above the reaction chambers via a ring gap formed by an encasing tube and surrounding a lower of the measuring tube in the longitudinal direction wherein a seal of a connection between the measuring tube and corresponding reaction chamber is loosened so that an orifice is formed between a space above a flexible solid body bed in the reaction chamber and the ring gap.

6. The method according to claim 5, further comprising allowing the resultant back pressure to decay.

7. The method according to claim 5, wherein the solid body bed is loosened by back flow of the measuring gas from the reaction chamber volume above the solid body bed.

8. The method according to claim 7, wherein catalyst-filled tube-bundle reactors are used.

9. The method according to claim 5, wherein catalyst-filled tube-bundle reactors are used.

10. An apparatus for measurement of the even filling of reactors which contain at least two reaction chambers or reaction tubes with solid bodies, the apparatus comprising:
at least two devices which are not fastened to one another and are configured to constantly meter gas or liquid streams and, in association therewith, have the same respective number of devices having a measuring tube configured to measure back pressure; and
a central data store for recording the measured values,
wherein the measuring tube introduced into each respective reaction chamber or reaction tube, or seated thereon, is encased with a tube case at an introduction end in a longitudinal direction so that a ring gap forms which has a venting port, the tube case being longer than the measuring tube and having a larger cross section than an inlet orifice into which the measuring tube is introduced or on which it sits, and wherein the inlet orifice is enclosed so that no gas escapes during the measurement operation for the back pressure.
